(19) United States
(12) Patent Application Publication
(10) Pub. No.: US 2005/0000930 A1
(43) Pub. Date: Jan. 6, 2005

(54) Nursing bottle with attached toy figure

(75) Inventor: Hans Weissberg, Zurich (CH)

Correspondence Address: BRIAN M BERLINER, ESQ;O'MELVENY & MYERS, LLP, 400 SOUTH HOPE STREET, LOS ANGELES, CA, 90071-2899, US

(73) Assignee: CLIP-TOYS AKTIENGESELLSCHAFT

(21) Appl. No.: 10/805,134

(22) Filed: Mar. 19, 2004

Related U.S. Application Data
(63) Continuation-in-part of application No. 29/158,615, filed on Apr. 5, 2002, now Pat. No. D497002.

(30) Foreign Application Priority Data
Oct. 8, 2001 (DE) 401 09 065.5

(51) Int. Cl. A61J 9/08; A63H 33/00; A63H 3/00

(52) U.S. Cl. 215/11.6; 446/74

(57) ABSTRACT

A toy figure resembling an animate being is attached to any suitable nursing bottle. The toy figure is oriented with its belly towards the nursing bottle, and its head facing towards the nursing end of the bottle, as if looking towards the nipple. The toy figure has a plurality of appendages, for example, legs, arms, or flippers, that may be posed at least partly around the circumference of the bottle, so that the figure appears to be embracing or riding on the bottle. The nursing bottle with attached toy figure is useful for stimulating interest and a desire to nurse in a nursing child. It may also be used to distinguish between bottles intended for different children.

### RELATED APPLICATION

This application is a continuation-in-part of co-pending application Ser. No. 29/158,615, filed Apr. 5, 2002.

### BACKGROUND OF THE INVENTION

1. Field of the Invention

The present invention relates to bottles with nipples for dispensing fluids, such as are used for the care and feeding of infants and young children.

2. Description of Related Art

Various enhancements to nursing bottles are known, directed towards making the drinking of milk or other fluids from the bottle more attractive for the child, thereby encouraging the child to drink. For example, attachments for nursing bottle which employ music and/or colorful lights have been disclosed in the art. It is also known to decorate nursing bottles with colorful pictures that a child will find attractive, and to provide fanciful shapes for structures used to hold nursing bottles in a nursing position, or to keep them warm. All of these types of enhancements to undecorated nursing bottles may be regarded as enhancing the pleasure and/or sense of security and satisfaction that an infant or young child associates with nursing.

Notwithstanding their advantages, however, such enhancements are subject to certain limitations. Musical or lighted attachments require a power source, and are susceptible to being damaged or rendered inoperative in the demanding and somewhat messy nursery environment. In addition, music and lights alone, even to the extent regarded as entertaining rather than distracting, are somewhat unlikely to engender an emotional bond from a child that might beneficially transfer to the act of nursing. Decorated bottle holders in fanciful shapes are associated with the bottle when it is being held, but not when the bottle is removed from the holder and is held by the infant or young child. Thus, the child may perceive a separation or distance between the fanciful shape of the bottle holder and the bottle itself. Figures that are merely painted or embossed on a nursing bottle avoid the problem of separation, but lack the tactile and visual stimulus of a three-dimensional figure. Such two-dimensional figures, much like musical tones and lights, are not likely to stimulate the imagination of the child in a way that causes the child to develop a bond with the figure and an associated increase in the pleasure and satisfaction of nursing.

It is desirable, therefore, to provide an improved nursing bottle for stimulating a emotional bond from a nursing child, without the limitations of prior art nursing bottles and bottle holders.

### SUMMARY OF THE INVENTION

The present invention provides a nursing bottle that overcomes the limitations of the prior art. In an embodiment of the invention, a toy figure resembling an animate being is attached to any suitable nursing bottle. For example, the nursing bottle may comprise a relatively rigid, generally tubular bottle of a size suitable for grasping by a nursing child. The bottom of the bottle may be generally flat for resting the bottle on flat working surfaces, and the top of the bottle may be provided with a screw-top opening for attaching a nipple.

The toy figure may be of comparable size to the bottle; for example, in the range of about one-quarter the size of the bottle to about the same size as the bottle. The toy figure may be oriented with its belly towards the nursing bottle, and its head facing towards the nursing end of the bottle, as if looking towards the nipple. The toy figure may comprise a plurality of appendages, for example, legs, arms, or flippers, that may be posed at least partly around the circumference of the bottle, so that the figure appears to be embracing or riding on the bottle.

The toy figure may be removably attached to the nursing bottle, for example, by using fasteners to attach the figure directly to the bottle, or to attach appendages of the figure together so as to clasp the bottle. In addition, or in the alternative, appendages of the toy figure may be configured to clasp the nursing bottle by virtue of a molded-in resiliency, or using an internal spring. If the toy figure is removable, it may readily be removed from the bottle for washing, and reattached after washing. The toy figure may be attached so that it may be rotated with respect to the bottle, or in the alternative, may remain in a fixed orientation relative to the bottle.

A removable toy figure may suitably be a plush toy, or a molded toy. If molded, the surface of the toy may be painted with durable non-toxic paints or otherwise colored to provide a colorful and attractive appearance. The toy figure should be constructed using light-weight materials and design, so that the weight of the nursing bottle with the attached figure is minimized. The overall construction should be child-safe; for example, no breakable or toxic materials should be used, and the toy figure should not have any removable parts that may pose a choking hazard.

In the alternative to a removable attachment, the toy figure may be more permanently attached to the bottle. For example, the toy figure may be co-molded with the bottle, or may be adhered to the bottle using a suitable adhesive that will not be degraded by washing. If not removably attached to the bottle, the toy figure should be made and colored using materials that will stand up to repeated washing in hot soapy water.

Thus, a nursing bottle may be provided with a durable attractive toy figure that mirrors the child's own relationship of support and affection towards the bottle, thereby engendering an emotional bond and reinforcing a positive association with nursing. In a nursery setting, a further advantage of the invention is that bottles belonging to different children may more readily be distinguished by assigning a particular type of toy figure to each child. A more complete understanding of the nursing bottle with attached toy figure will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1A is a front perspective view of a teddy bear toy figure on a nursing bottle according to the present invention.

FIG. 1B is a rear perspective view of FIG. 1A.

FIG. 2 is a front perspective view of a leopard toy figure on a nursing bottle according to the present invention.

FIG. 3 is a front perspective view of a female lion toy figure on a nursing bottle according to the present invention.

FIG. 4A is a front perspective view of a male lion toy figure on a nursing bottle according to the present invention.

FIG. 4B is a rear perspective view of FIG. 4A.

FIG. 5 is a front perspective view of a lynx toy figure on a nursing bottle according to the present invention.

FIG. 6 is a front perspective view of a human girl toy figure on a nursing bottle according to the present invention.

FIG. 7 is a front perspective view of a chipmunk toy figure on a nursing bottle according to the present invention.

FIG. 8 is a front perspective view of a rat toy figure on a nursing bottle according to the present invention.

FIG. 9A is a front perspective view of a guinea pig without tail toy figure on a nursing bottle according to the present invention.

FIG. 9B is a rear perspective view of FIG. 9A.

FIG. 10 is a front perspective view of a hippopotamus toy figure on a nursing bottle according to the present invention.

FIG. 11A is a front perspective view of a panda toy figure on a nursing bottle according to the present invention.

FIG. 11B is a rear perspective view of FIG. 11A.

FIG. 12 is a front perspective view of a horse toy figure on a nursing bottle according to the present invention.

FIG. 13 is a front perspective view of a penguin toy figure on a nursing bottle according to the present invention.

FIG. 14 is a front perspective view of a deer toy figure on a nursing bottle according to the present invention.

FIG. 15 is a front perspective view of a seal toy figure on a nursing bottle according to the present invention.

FIG. 16 is a front perspective view of a lamb toy figure on a nursing bottle according to the present invention.

FIG. 17 is a front perspective view of a turtle toy figure on a nursing bottle according to the present invention.

FIG. 18 is a front perspective view of a pig toy figure on a nursing bottle according to the present invention.

FIG. 19 is a front perspective view of an alligator toy figure on a nursing bottle of the preset invention.

FIG. 20A is a front perspective view of a house cat toy figure on a nursing bottle according to the present invention.

FIG. 20B is a rear perspective view of FIG. 20A.

FIG. 21 is a front perspective view of a walrus toy figure on a nursing bottle according to the present invention.

FIG. 22 is a front perspective view of a cow toy figure on a nursing bottle according to the present invention.

FIG. 23 is a front perspective view of a tiger toy figure on a nursing bottle according to the present invention.

FIG. 24 is a front perspective view of a raccoon toy figure on a nursing bottle according to the present invention.

FIG. 25A is a front perspective view of a puppy toy figure on a nursing bottle according to the present invention.

FIG. 25B is a rear perspective view of FIG. 25A.

FIG. 26 is a front perspective view of a wolf toy figure on a nursing bottle according to the present invention.

FIG. 27 is a front perspective view of a zebra toy figure on a nursing bottle according to the present invention.

FIG. 28 is a front perspective view of a duckling toy figure on a nursing bottle according to the present invention.

FIG. 29 is a front perspective view of a koala bear toy figure on a nursing bottle according to the present invention.

FIG. 30 is a front perspective view of an otter toy figure on a nursing bottle according to the present invention.

FIG. 31 is a front perspective view of a donkey toy figure on a nursing bottle according to the present invention.

FIG. 32 is a front perspective view of an elephant toy figure on a nursing bottle according to the present invention.

FIG. 33A is a front perspective view of a polar bear toy figure on a nursing bottle according to the present invention.

FIG. 33B is a rear perspective view of FIG. 33A.

FIG. 34A is a front perspective view of a monkey toy figure on a nursing bottle according to the present invention.

FIG. 34B is a rear perspective view of FIG. 34A.

FIG. 35A is a front perspective view of a squirrel toy figure on a nursing bottle according to the present invention.

FIG. 35B is a rear perspective view of FIG. 35A.

FIG. 36 is a front perspective view of a dolphin toy figure on a nursing bottle according to the present invention.

FIG. 37 is a front perspective view of a weasel toy figure on a nursing bottle according to the present invention.

FIG. 38 is a front perspective view of a naturalistic bear toy figure on a nursing bottle according to the present invention.

FIG. 39 is a front perspective view of a frog toy figure on a nursing bottle according to the present invention.

FIG. 40 is a front perspective view of a fox toy figure on a nursing bottle according to the present invention.

FIG. 41 is a front perspective view of a guinea pig with tail toy figure on a nursing bottle according to the present invention.

FIG. 42A is a front perspective view of a rabbit toy figure on a nursing bottle according to the present invention.

FIG. 42B is a rear perspective view of FIG. 42A.

FIG. 43 is a front perspective view of a hound dog toy figure on a nursing bottle according to the present invention.

FIG. 44 is a front perspective view of a sheep dog toy figure on a nursing bottle according to the present invention.

FIG. 45 is a front perspective view of a Spaniel dog toy figure on a nursing bottle according to the present invention.

FIG. 46 is a front perspective view of a human boy toy figure on a nursing bottle according to the present invention.

FIG. 47 is a front perspective view of a hedgehog toy figure on a nursing bottle according to the present invention.

FIG. 48 is a front perspective view of a kangaroo toy figure on a nursing bottle according to the present invention.

FIG. 49 is a front perspective view of a camel toy figure on a nursing bottle according to the present invention.

FIG. 50 is a front perspective view of a chick toy figure on a nursing bottle according to the present invention.

FIGS. 51A-C show a teddy bear figure similar to that shown in FIGS. 1A-B, wherein the toy figure is rotatably attached to the nursing bottle, in exemplary orientations with respect to the bottle.

FIG. 52 shows an cross-sectional view of an exemplary attachment for a toy figure configured for permitting rotation of the toy figure.

FIG. 53A shows an exemplary plush teddy-bear figure clipped to a nursing bottle by its front legs.

FIG. 53B shows the plush figure of FIG. 53A from another angle, without the bottle.

FIG. 54A shows an exemplary plush puppy figure clipped to a nursing bottle by its front legs.

FIG. 54B shows the plush figure of FIG. 54A from another angle, without the bottle.

FIG. 55A shows an exemplary plush kitten figure clipped to a nursing bottle by its front legs.

FIG. 55B shows the plush figure of FIG. 55A from another angle, without the bottle.

### DETAILED DESCRIPTION OF THE PREFERRED EMBODIMENT

The present invention provides a nursing bottle assembly with a decorative attachment, that overcomes the limitations of the prior art. In the detailed description that follows, like element numerals are used to describe like elements appearing in one or more of the figures.

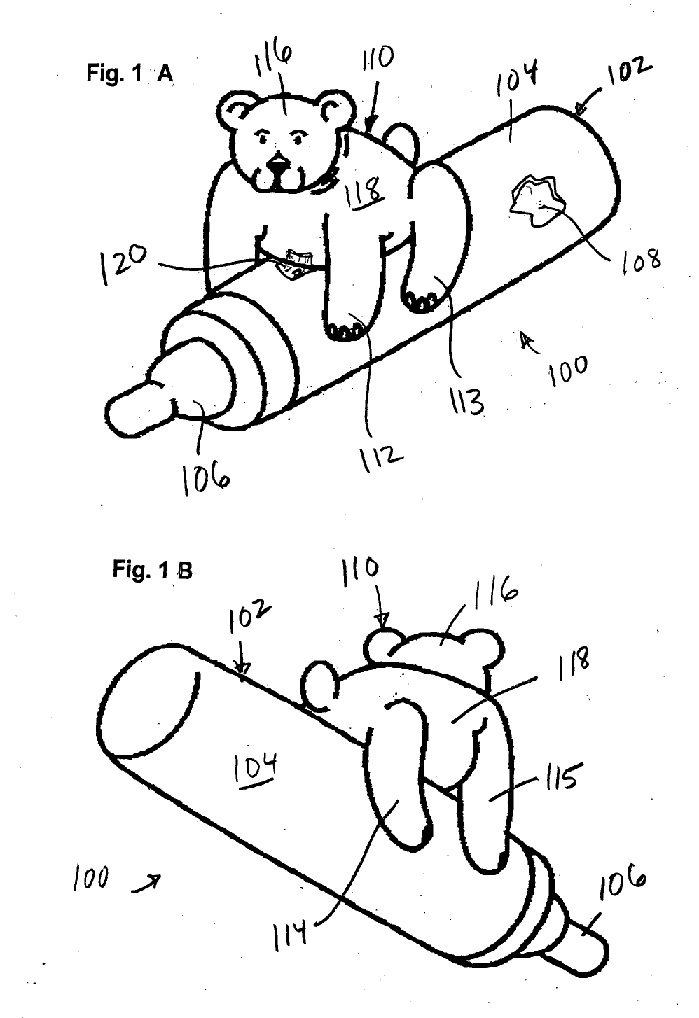

Referring to FIGS. 1A-1B, an exemplary nursing bottle assembly 100 is shown, comprising a toy figure 110 in the shape of a teddy bear attached to a nursing bottle 102. Bottle 102 may comprise a substantially rigid housing 104 having a nipple 106 disposed at a first end of the housing. The nipple 106 may be in fluid communication with a contained space 108 inside housing 104. For example, bottle 102 may comprise a molded bottle with a screw-top opening for attaching a nipple, as known in the art. Other suitable materials for bottle 102 may include glass, stainless steel, or aluminum, although any other suitable material may also be used.

Toy figure 110 is shaped to resemble a three-dimensional animate being, for example, a teddy bear, and may be attached to housing 104. Toy figure 110 may comprise a head 116 supported by a body 118 having a plurality of appendages 112-115. The toy figure may be oriented with its body 118 disposed along the housing 104 between the top of the housing and the bottom of the housing, the plurality of appendages 112-115 disposed at least partly around the housing of the nursing bottle, and head 118 oriented towards nipple 106. In this pose, toy figure 110 may appear to be riding astride or embracing the nursing bottle, with its attention directed towards the nipple and therefore also facing the child during nursing. The toy figure should be large enough to be relatively prominent, but not so large so as to unduly interfere with handling or storage of assembly 100. In general, sizes in the range of about one-quarter to about the same size as housing 104 are believed to be preferable, although the invention is not strictly limited to sizes in this range.

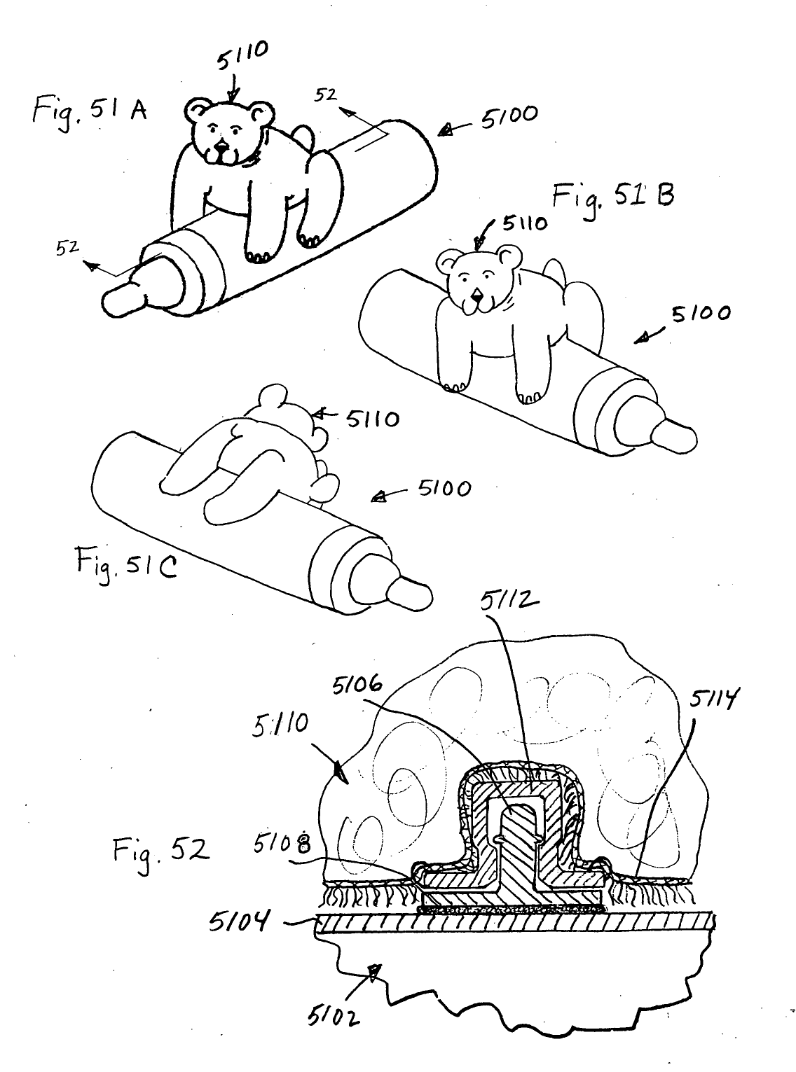

In an embodiment of the invention, the toy figure may be attached to bottle 102 using a fastener 120. Fastener 120 may be of a type that is readily detachable and re-attachable; for example, a fabric hook-and-loop assembly, a snap, or any other suitable fastener. Fastener 120 may hold the toy figure in a fixed orientation with respect to bottle 102. In the alternative, fastener 120 may permit relative rotation between the toy figure and the bottle, as discussed in more detail below in connection with FIGS. 51A-C and 52. In another alternative embodiment, the toy figure may be more permanently attached to housing 104. For example, it may be adhered to the housing using a suitable adhesive that will not degrade with repeated washing. For further example, the toy FIG. 116 may be co-molded with housing 104, in which case it may comprise the same material as the housing, or a compatible material. Yet another alternative is to configure the plurality of appendages 112-115 as a kind of clasp for clasping toy FIG. 110 to the housing 104. Each opposing pair of appendages may be configured for resiliently clasping the housing, such as by forming the appendages of a resilient material and biasing them together in opposing pairs, or providing a suitable spring mechanism inside the toy figure. Or, the appendages may be drawn all the way around the circumference of the bottle and joined together, like a strap. Other options for attaching the toy figure to the bottle may also be used, for example, an elastic band or a harness that wraps around the housing and is attached to the toy figure.

The toy figure 110 may generally be of two alternative types: a removable plush toy, such as a stuffed animal, or a molded plastic toy, which may be either removable or fixed. To minimize the weight and cost of the figure, a molded figure may be hollow. Molded toy figures may be colored or painted as known in the art to enhance their visual appeal. Such toy figures may be made suitable for washing, such as in a dishwasher, thereby preventing build-up of milk residue. Likewise, a plush toy may be made using different types and hues of plush fabric, and filled with a soft stuffing, as known in the art. It may be made in a manner suitable for laundering, to maintain the plush toy in a clean and hygienic condition.

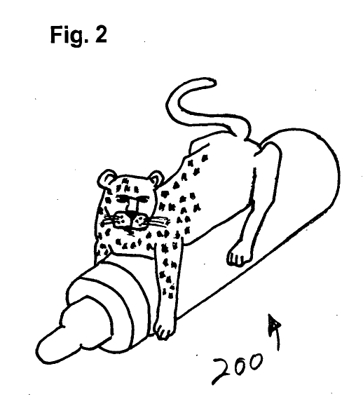

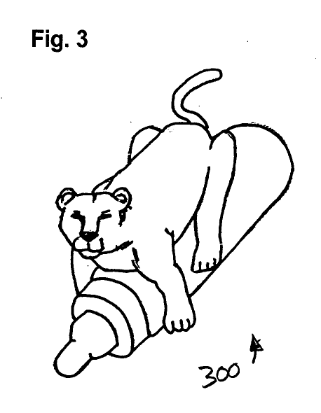

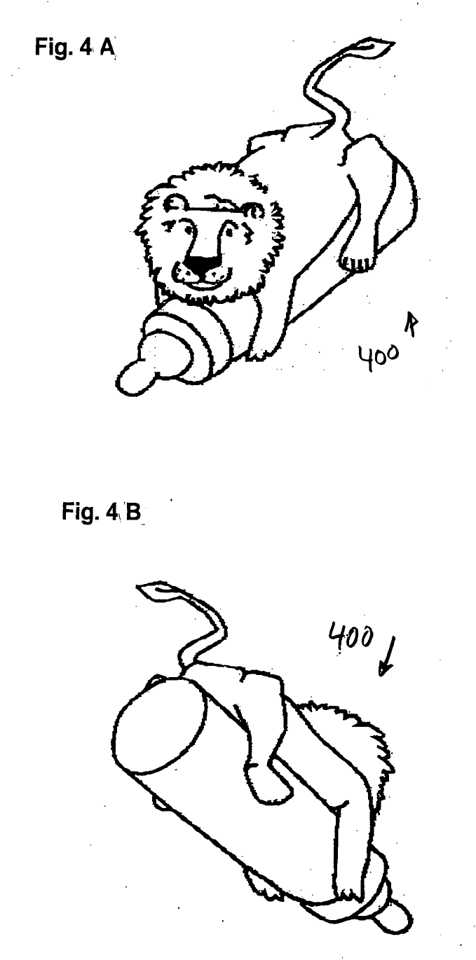

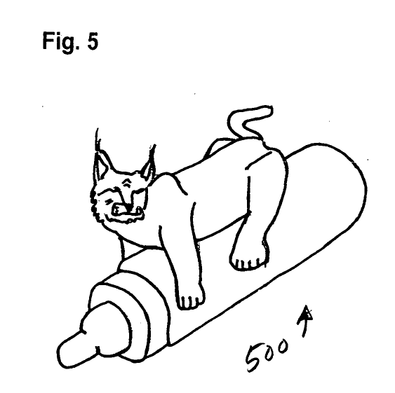

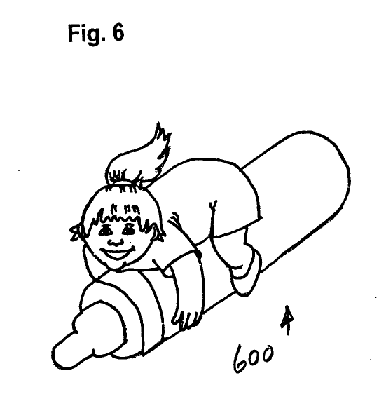

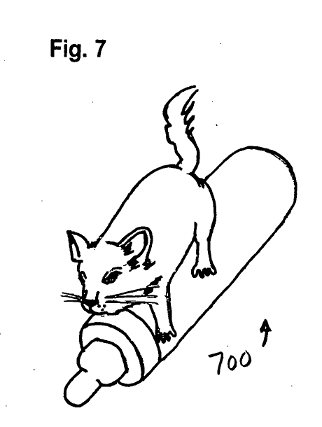

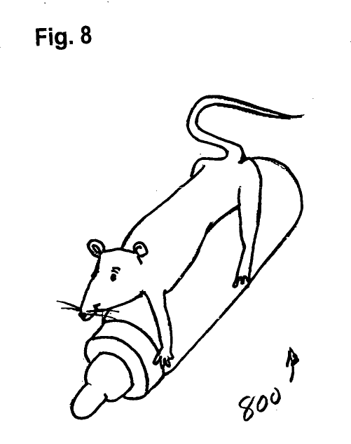

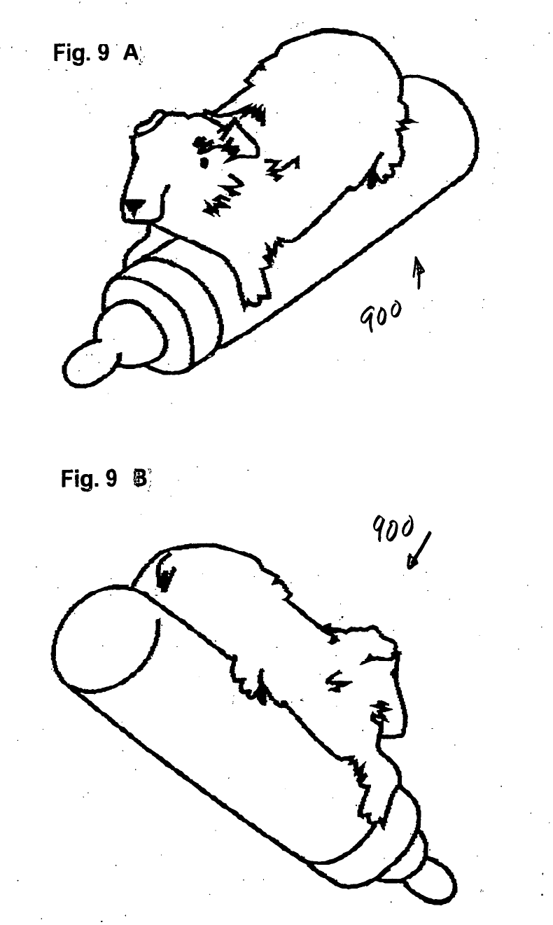

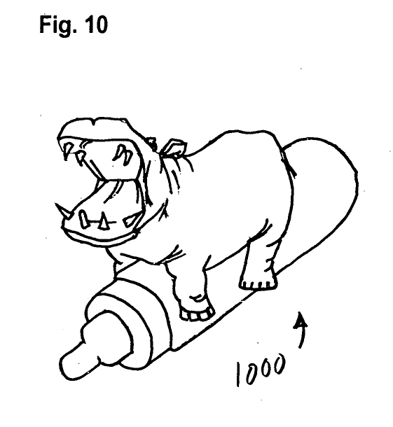

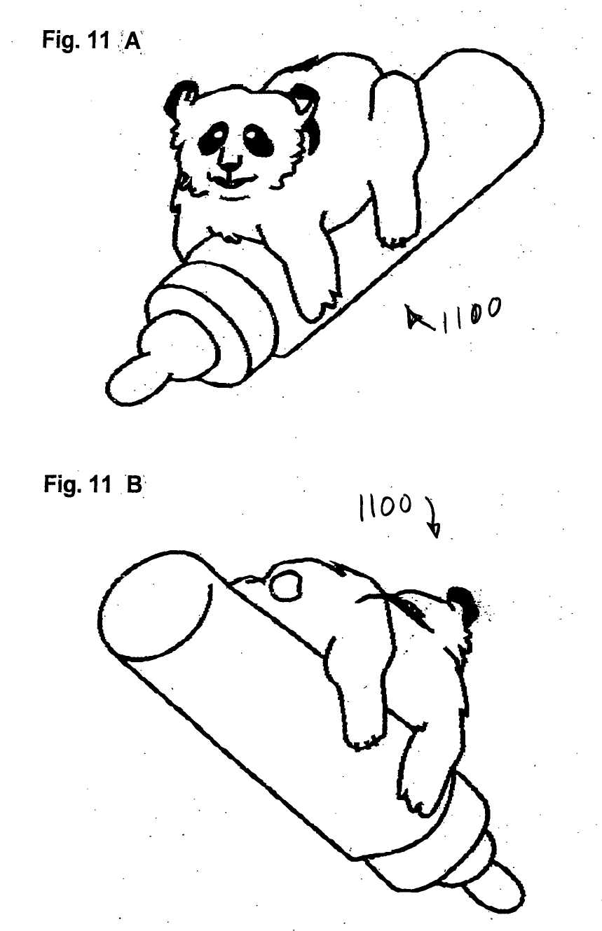

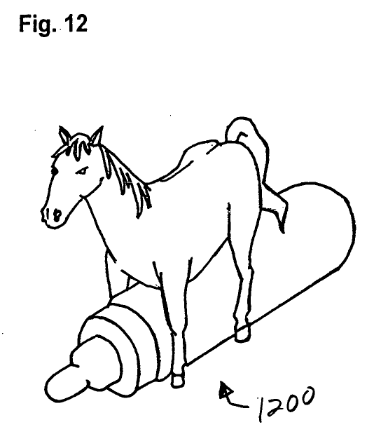

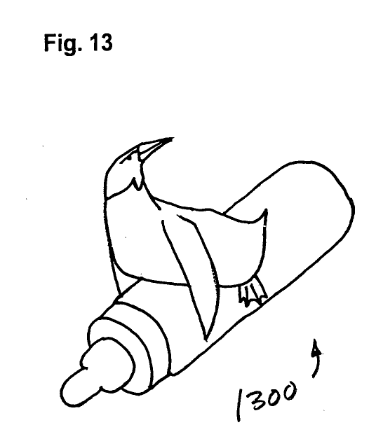

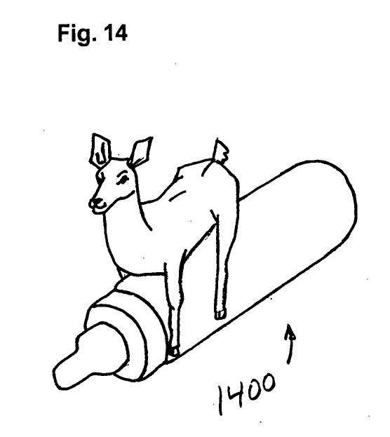

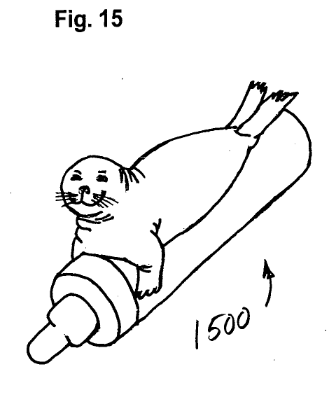

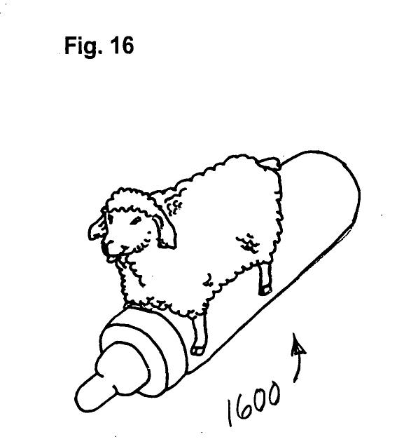

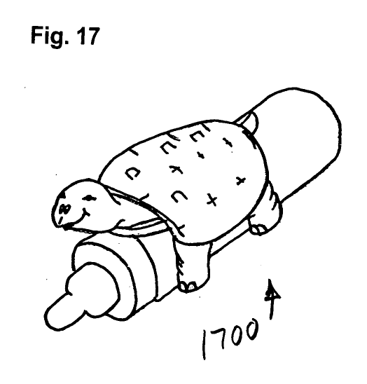

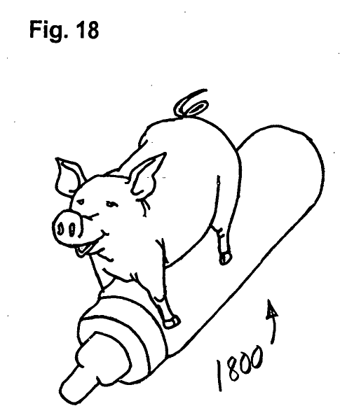

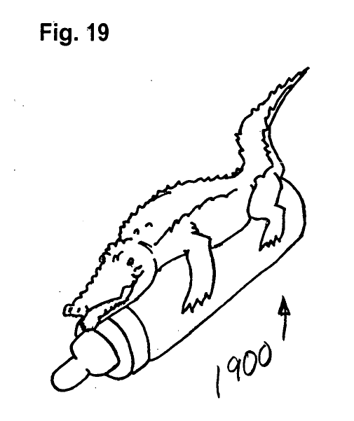

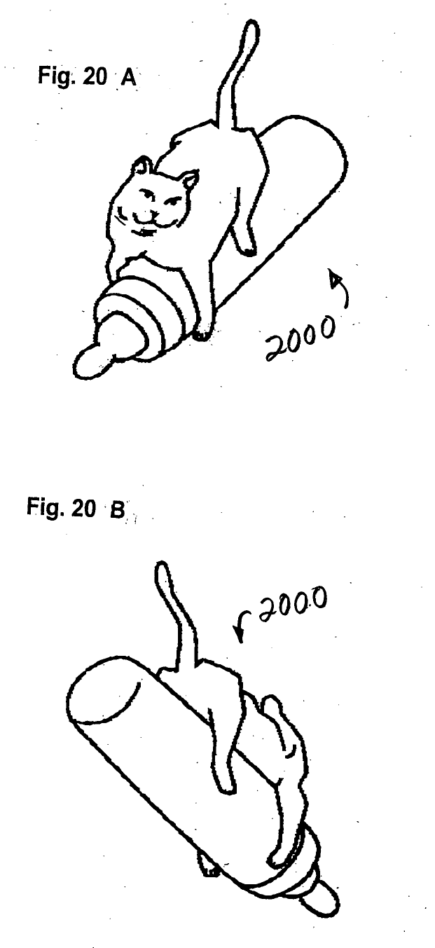

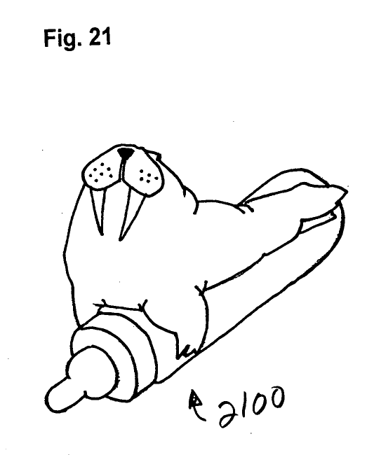

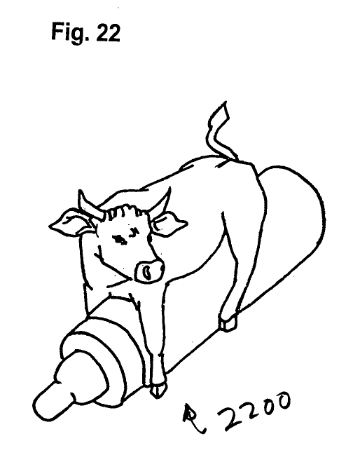

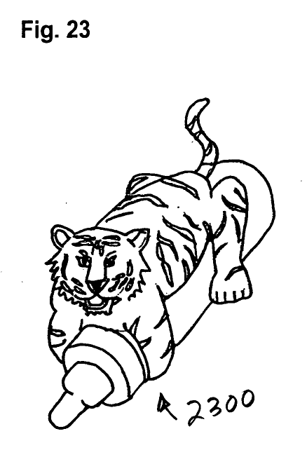

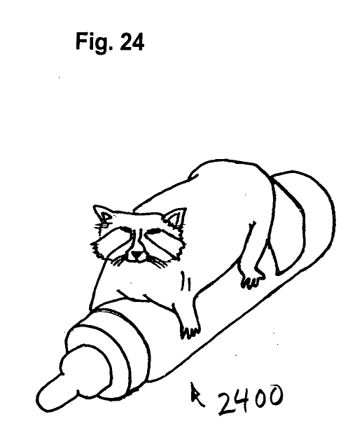

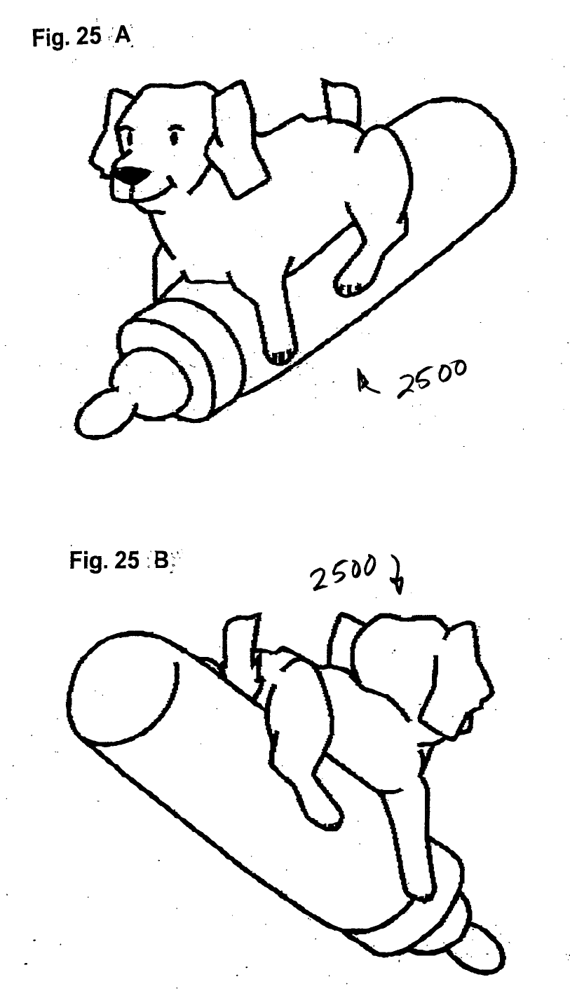

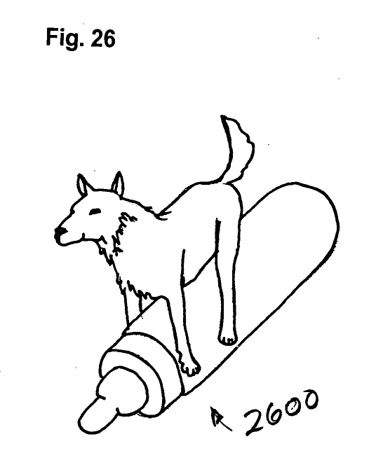

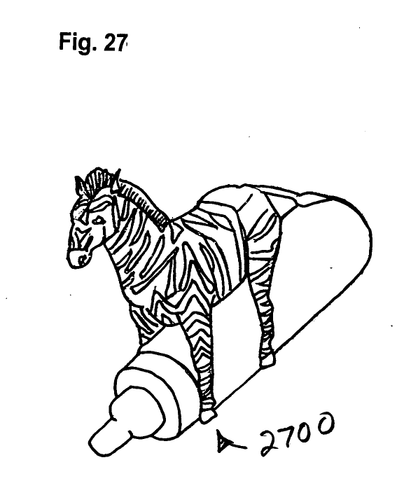

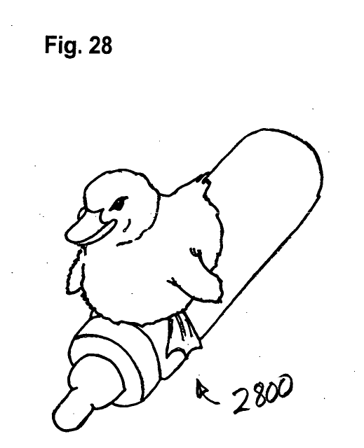

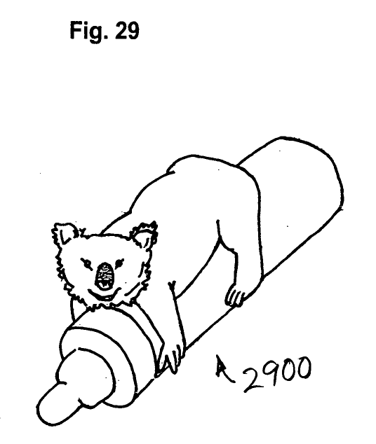

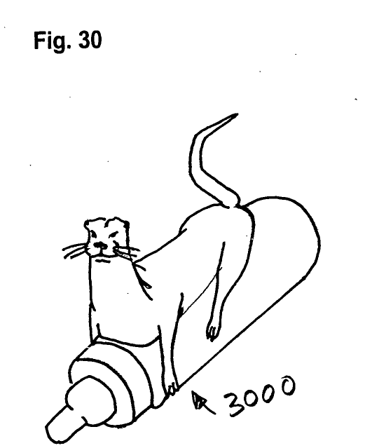

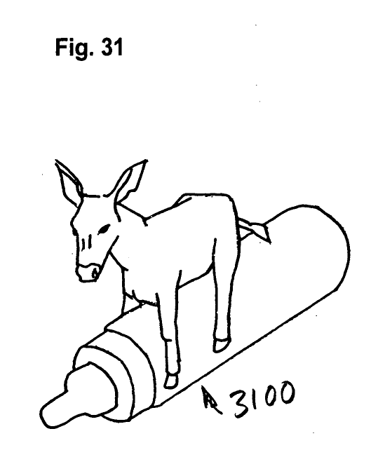

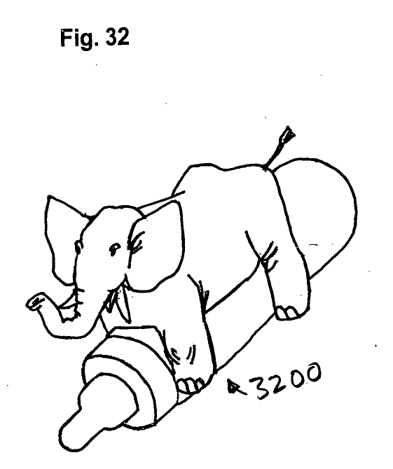

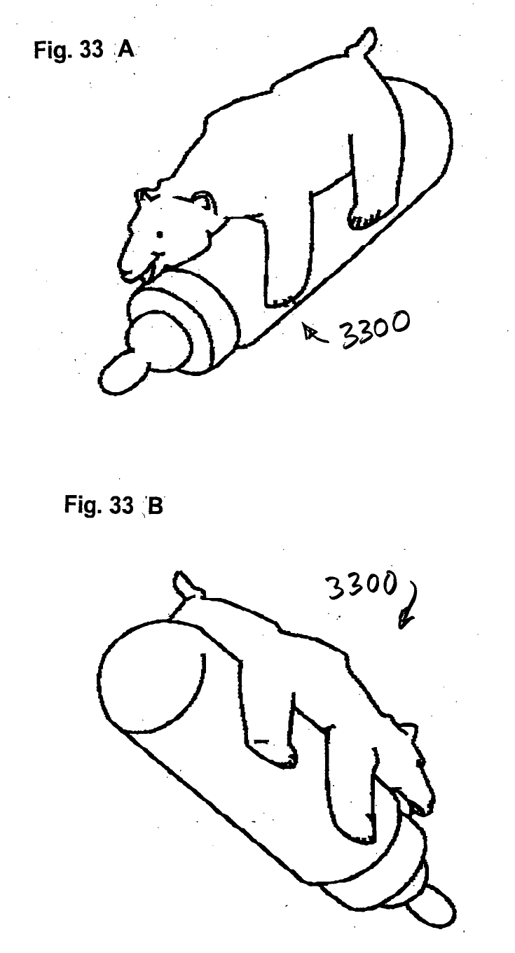

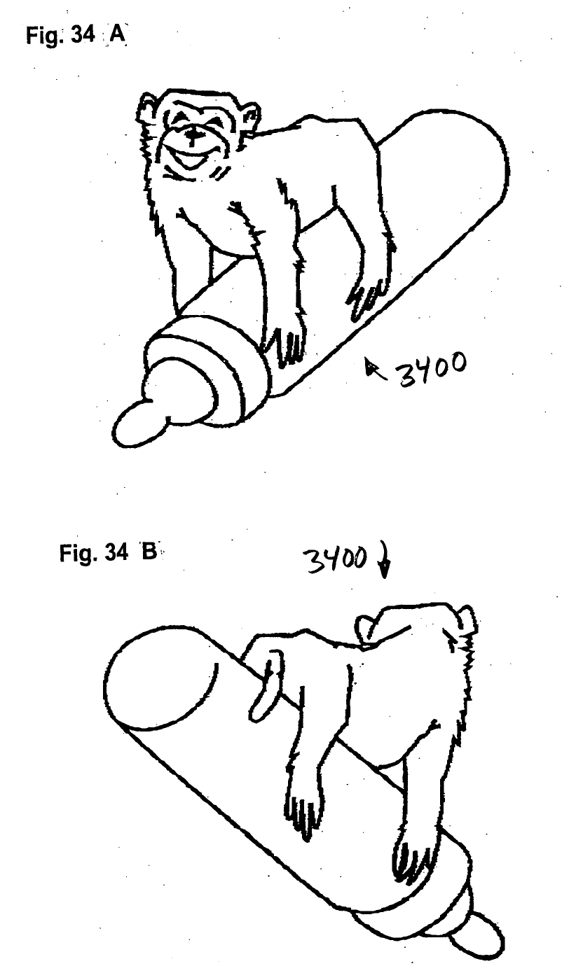

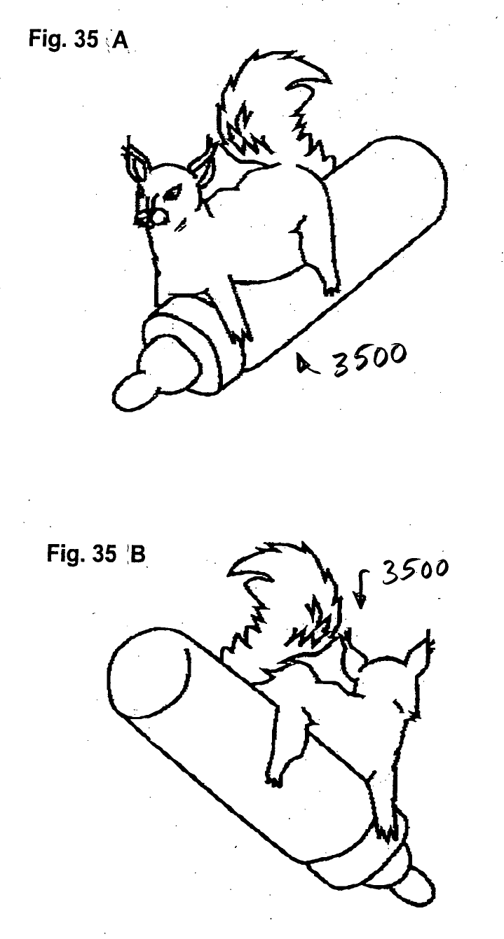

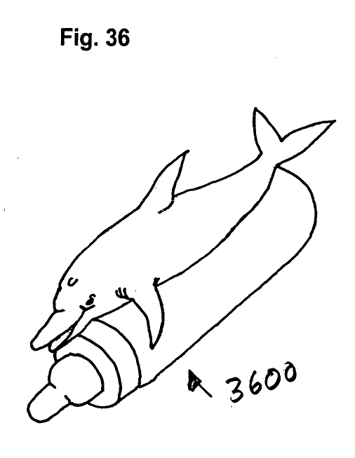

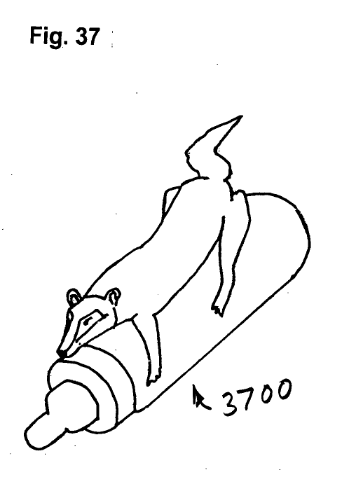

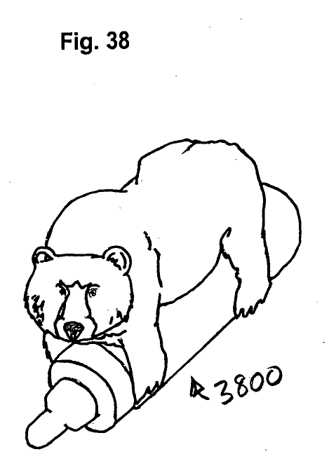

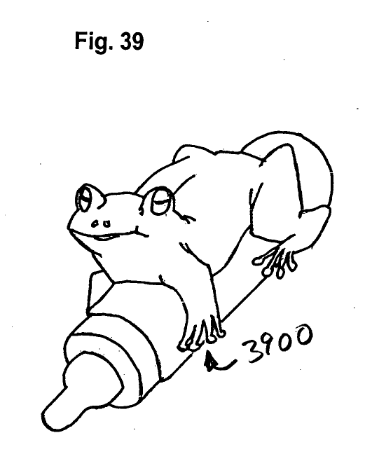

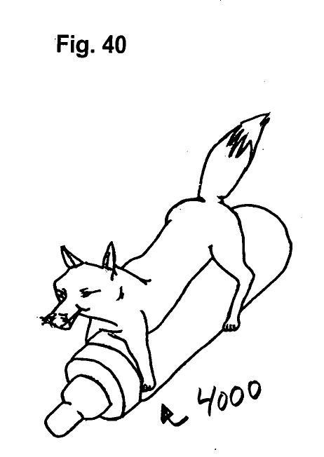

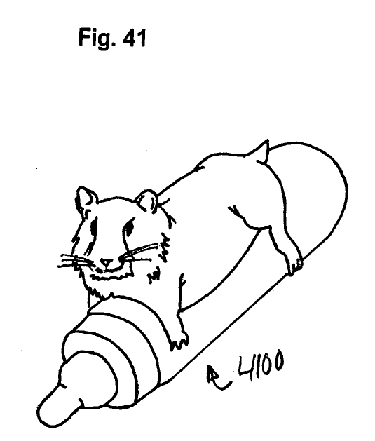

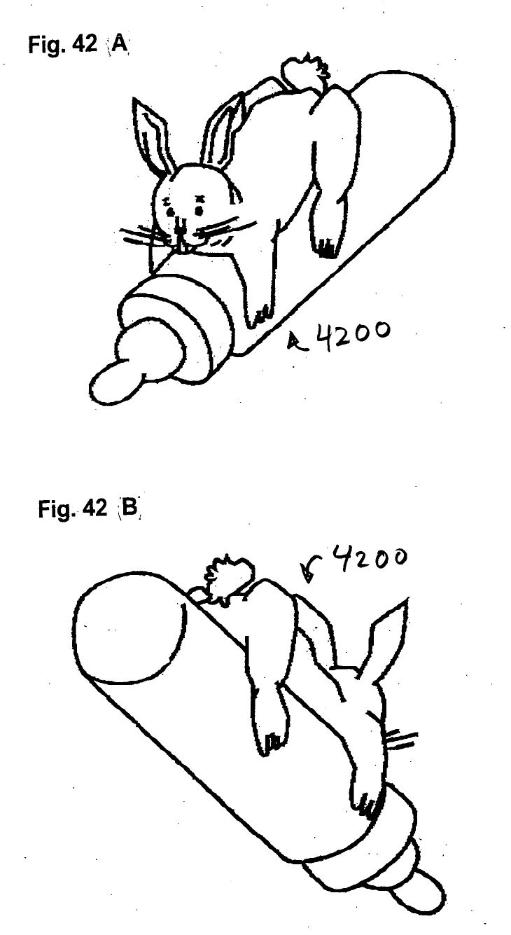

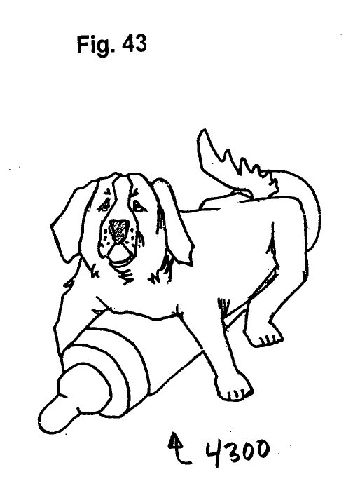

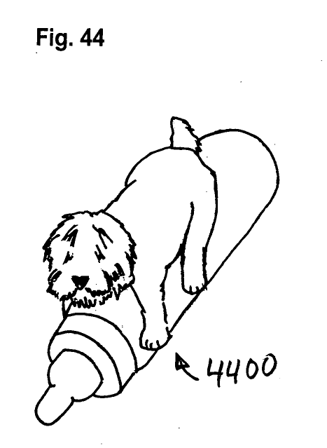

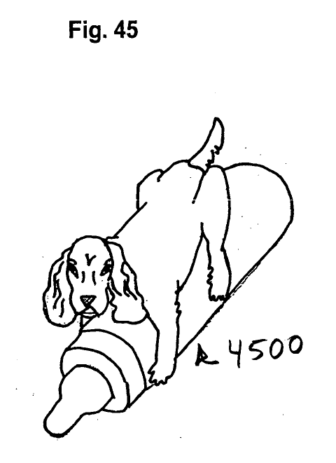

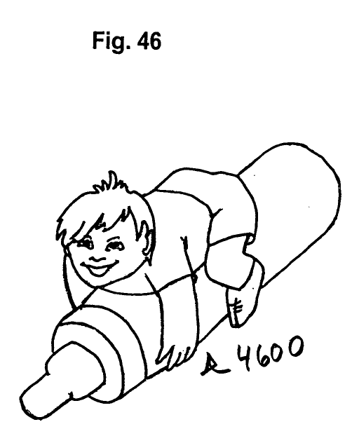

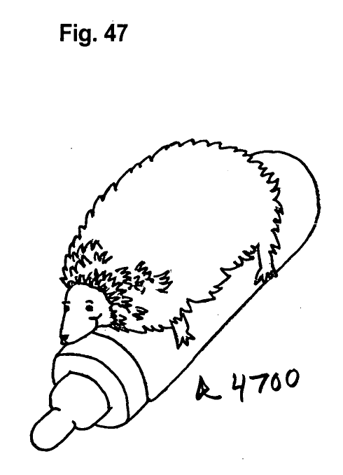

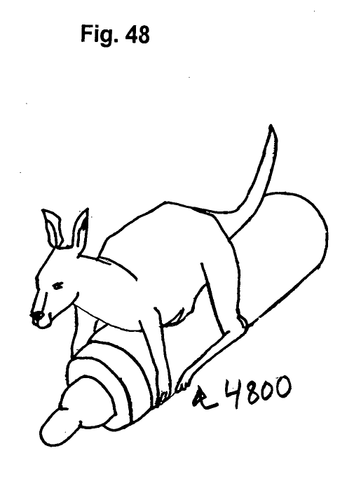

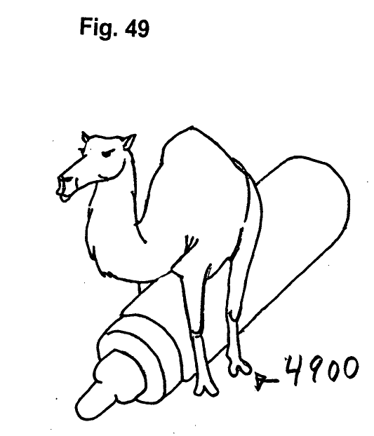

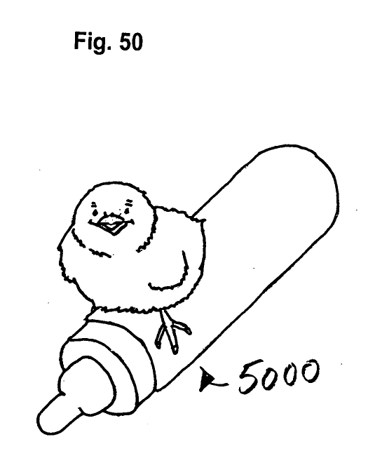

Referring to FIGS. 2-50, various alternative nursing bottles assemblies 200-5000, each comprising a different style of toy figure, are depicted. Each of the toy figures in assemblies 200-5000 resembles an animate being in a pose analogous to that shown and described in connection with FIGS. 1A-1B. The toy figures include: a leopard (FIG. 2), a female lion (FIG. 3), a male lion (FIGS. 4A-B), a lynx (FIG. 5), a human girl (FIG. 6), a chipmunk (FIG. 7), a rat (FIG. 8), a guinea pig (FIGS. 9A-B), a hippopotamus (FIG. 10), a panda (FIGS. 11A-B), a horse (FIG. 12), a penguin (FIG. 13), a deer (FIG. 14 ), a seal (FIG. 15), a lamb (FIG. 16), a turtle (FIG. 17), a pig (FIG. 18), an alligator (FIG. 19), a house cat (FIGS. 20A-B), a walrus (FIG. 21), a cow (FIG. 22), a tiger (FIG. 23), a raccoon (FIG. 24), a puppy (FIGS. 25A-B), a wolf (FIG. 26), a zebra (FIG. 27), a duckling (FIG. 28), a koala bear (FIG. 29), an otter (FIG. 30), a donkey (FIG. 31), an elephant (FIG. 32), a polar bear (FIGS. 33A-B), a monkey (FIGS. 34A-B), a squirrel (FIGS. 35A-B), a dolphin (FIG. 36), a weasel (FIG. 37), a naturalistic bear (FIG. 38), a frog (FIG. 39), a fox (FIG. 40), a guinea pig (FIG. 41), a rabbit (FIGS. 42A-B), a hound dog (FIG. 43), a sheep dog (FIG. 44), a Spaniel dog (FIG. 45), a human boy (FIG. 46), a hedgehog (FIG. 47), a kangaroo (FIG. 48), a camel (FIG. 49), and a chick (FIG. 50).

Although mostly naturalistic figures are depicted, a suitable toy figure may also comprise an imaginary creature of any type. A toy figure of any type may be equipped with battery-powered lights or musical tones, as known in the toy art. The toy figure may be configured to illuminate lights and/or play musical tones when the bottle is held at an angle suitable for nursing. Such embodiments may encourage a child to nurse, as well as provide a signal for the caregiver to indicate that the child is nursing. Suitable circuits for lights and musical tones, with or without being activated by the degree of tilt of the bottle, may be provided as known in the art.

It should be apparent that toy figures that are configured for removable attachment to a bottle may be made interchangeable, so that different styles of toy figures may be attached to the same nursing bottle. A collection of different animal shapes may be used to stimulate the interest of a child in the nursing bottle, for example by attaching a different animal at different times. In addition, in a nursery setting with many nursing children, differently-shaped toy figures may be used to distinguish between bottles used by different children.

It may be advantageous to attach a toy figure to a bottle so that the toy figure can be rotated with respect to the bottle. FIGS. 51A-C illustrate such an attachment in an assembly 5100 having a toy figure 5110 similar to toy figure 110 shown in FIGS. 1A-B. In FIG. 51A, toy figure 5110 is shown in essentially the same pose with respect to bottle 5102 as toy figure 110 in FIGS. 1A-B. In FIG. 51B, toy figure 5110 is rotated 90° with respect to its orientation in FIG. 51A. FIG. 51C shows the toy figure rotated 180° with respect to its position shown in FIG. 51A. Toy figure 5110 may be a plush toy or molded figure. Toy figure 5110 may be freely rotatable with respect to the bottle, so that it may be twirled by a nursing child. In such embodiments, the appendages of the toy figure should be configured so as to not unduly interfere with rotation, such as by being made suitably short and/or flexible. In the alternative, the toy figure and its attachment may be configured so that only certain defined orientations relative to the bottle are possible, and rotation does not freely occur.

FIG. 52 shows an exemplary attachment 5120 for attaching a toy figure 5110, such as a plush toy, to a wall 5104 of a nursing bottle 5102. A generally cylindrical post 5106 may be adhered to wall 5104 using any suitable adhesive 5108. In the alternative, post 5106 may comprise a feature that is co-molded with wall 5104. A corresponding receptacle 5112 may be formed in toy figure 5110, and may be configured to snap into place over an end portion of the post, while permitting rotation with respect to it. For a plush toy, receptacle 5112 may comprise a separately formed piece that may be attached to a plush fabric skin 5114 of the plush toy. In a molded toy figure, a suitable receptacle may be molded into an undersurface of the figure. Various alternative rotatable attachments may also be suitable. For example, an elastic band or tab may be attached to a toy figure and to a bottle, permitting a degree of twist and/or displacement between them.

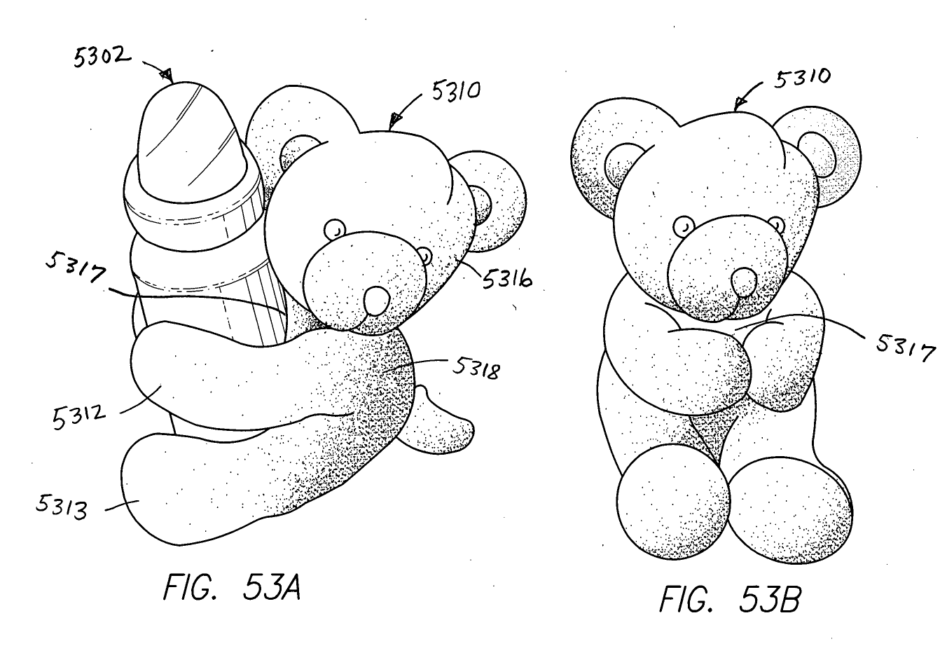

In an embodiment of the invention, the toy figure comprises a plush animal of comparable size to the nursing bottle, having plush front legs configured as spring clips for clasping the bottle. FIGS. 53A-55B show toy figures of this type. FIG. 53A shows a plush teddy-bear figure 5310 resiliently clasped to a nursing bottle 5302 by its front legs 5312. The head 5316 of the toy figure is oriented towards the nipple of the nursing bottle. Its body 5318 is disposed along a housing of bottle between its first and second ends. Bottle 5302 is inserted between rear legs 5313, but the rear legs need not be configured as a clasp. To enhance the toy figure's grip on bottle 5302, an underside 5317 of toy figure 5310 may comprise a fabric material having a high coefficient of friction relative to the outer housing of bottle 5302. For example, a swatch of rubberized fabric may be used for the belly area 5317 of figure 5310.

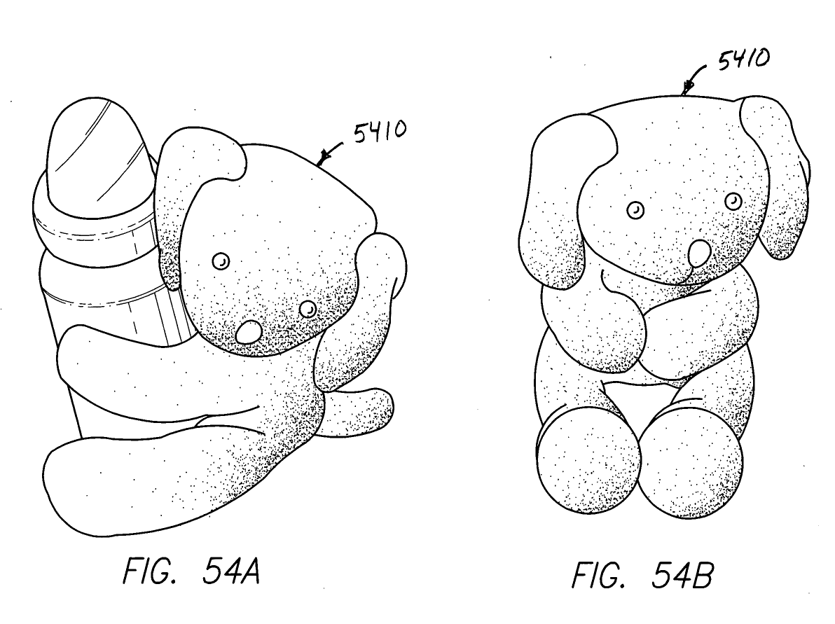

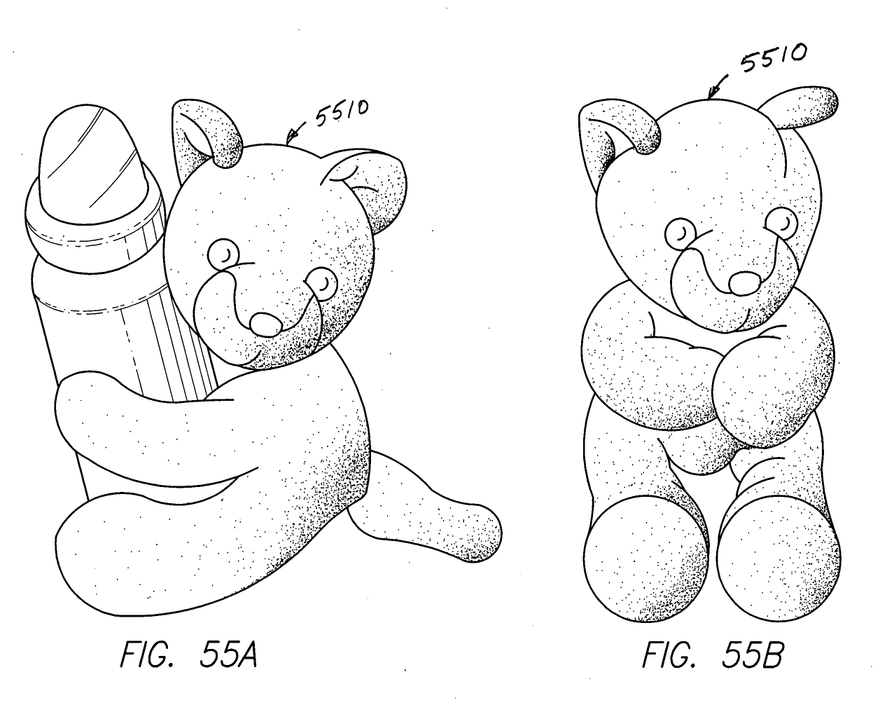

Unlike toy figures depicted in FIGS. 1A-51C, toy figure 5310 is large enough to serve as a bottle holder that keeps the bottle upright when not being used for nursing. Toy figure 5310 may be constructed from suitably lightweight materials so that it can remain attached to bottle 5302 without unduly increasing the total weight of material held by the child during nursing. Bottle 5302 may also be readily removed from the clasp of toy figure 5310. FIG. 53B shows teddy-bear figure 5310 with the bottle removed. FIGS. 54A-B show a plush puppy figure 5410 of a similar type, respectively clasped to and removed from a nursing bottle. Similarly, FIGS. 55A-B show a plush kitten figure 5510 in these respective configurations.

Having thus described a preferred embodiment of a nursing bottle with an attached toy figurine, it should be apparent to those skilled in the art that certain advantages of the within system have been achieved. It should also be appreciated that various modifications, adaptations, and alternative embodiments thereof may be made within the scope and spirit according to the present invention. For example, specific bottle and toy figure shapes have been illustrated, but it should be apparent that the inventive concepts described above would be equally applicable to other bottle shapes and types of figures resembling animate beings, whether real or imaginary. The invention is defined by the following claims.

1. An assembly, comprising:
a nursing bottle comprising a substantially rigid housing and a nipple disposed at a first end of the housing in fluid communication with a containment space inside the housing; and
a toy figure shaped to resemble a three-dimensional animate being attached to the nursing bottle, the toy figure comprising a plurality of appendages disposed at least partly around the housing of the nursing bottle, a head oriented towards the first end of the housing, and a body disposed along the housing between the first end and an opposing second end of the housing.

2. The assembly of claim 1, further comprising a fastener interposed between the toy figure and the housing, the fastener configured for attaching and detaching the toy figure to the nursing bottle.

3. The assembly of claim 2, wherein the fastener comprises a fabric hook-and-loop fastener.

4. The assembly of claim 2, wherein the fastener is configured to permit the toy figure to rotate relative to the nursing bottle.

5. The assembly of claim 2, wherein the fastener comprises a post engaged in a receptacle.

6. The assembly of claim 1, wherein the toy figure is configured to clasp the housing using the plurality of appendages.

7. The assembly of claim 6, wherein the plurality of appendages are disposed so as to resiliently clasp the housing therebetween.

8. The assembly of claim 1, wherein the toy figure is adhered to the nursing bottle.

9. The assembly of claim 1, wherein the toy figure is co-molded to the housing.

10. The assembly of claim 1, wherein the toy figure comprises a plastic molded object.

11. The assembly of claim 1, wherein the toy figure comprises a substantially hollow plastic molded object.

12. The assembly of claim 1, wherein the toy figure comprises a plush toy.

13. The assembly of claim 1, wherein the toy figure is shaped and colored to resemble a real animal.

14. The assembly of claim 1, wherein the toy figure is shaped to resemble an animate being selected from the group consisting of: a teddy bear, a leopard, a female lion, a male lion, a lynx, a human girl, a chipmunk, a rat, a guinea pig, a hippopotamus, a panda, a horse, a penguin, a deer, a seal, a lamb, a turtle, a pig, an alligator, a house cat, a walrus, a cow, a tiger, a raccoon, a puppy, a wolf, a zebra, a duckling, a koala bear, an otter, a donkey, an elephant, a polar bear, a monkey, a squirrel, a dolphin, a weasel, a naturalistic bear, a frog, a fox, a guinea pig, a rabbit, a hound dog, a sheep dog, a Spaniel dog, a human boy, a hedgehog, a kangaroo, a camel, and a chick.

15. A toy figure configured for attachment to a nursing bottle, the toy figure shaped to resemble a three-dimensional animate being and comprising:
a body having a undersurface resembling a belly of the animate being and a back surface resembling a back of the animate being;
a head attached to a first end of the body;
a plurality of appendages extending from the body away from its undersurface, the plurality of appendages shaped to fit at least partly around a housing of the nursing bottle as if to embrace it; and
means for attaching the toy figure to the housing of the nursing bottle.

16. The assembly of claim 15, wherein the means for attaching the toy figure to the housing comprises a fabric hook-and-loop fastener.

17. The assembly of claim 15, wherein the means for attaching the toy figure to the housing comprises a fastener configured to permit rotation between the toy figure and the housing.

18. The assembly of claim 15, wherein the means for attaching the toy figure to the housing comprises a post-and-receptacle fastener.

19. The assembly of claim 15, wherein the means for attaching the toy figure to the housing comprises a clasp that includes the plurality of appendages.

20. The assembly of claim 19, wherein the plurality of appendages are disposed so as to resiliently clasp the housing therebetween.

21. The assembly of claim 15, wherein the means for attaching the toy figure to the housing comprises an adhesive material disposed on the undersurface of the toy figure.

22. The assembly of claim 15, further comprising a nursing bottle housing co-molded to the toy figure.

23. The assembly of claim 15, wherein the toy figure comprises a plastic molded object.

24. The assembly of claim 15, wherein the toy figure comprises a substantially hollow plastic molded object.

25. The assembly of claim 15, wherein the toy figure comprises a plush toy.

26. The assembly of claim 15, wherein the toy figure is shaped and colored to resemble a real animal.

27. The assembly of claim 15, wherein the toy figure is shaped to resemble an animate being selected from the group consisting of: a teddy bear, a leopard, a female lion, a male lion, a lynx, a human girl, a chipmunk, a rat, a guinea pig, a hippopotamus, a panda, a horse, a penguin, a deer, a seal, a lamb, a turtle, a pig, an alligator, a house cat, a walrus, a cow, a tiger, a raccoon, a puppy, a wolf, a zebra, a duckling, a koala bear, an otter, a donkey, an elephant, a polar bear, a monkey, a squirrel, a dolphin, a weasel, a naturalistic bear, a frog, a fox, a guinea pig, a rabbit, a hound dog, a sheep dog, a Spaniel dog, a human boy, a hedgehog, a kangaroo, a camel, and a chick.
